(19) United States
(12) Patent Application Publication
(10) Pub. No.: US 2010/0126474 A1
(43) Pub. Date: May 27, 2010

(54) HIGH-PRESSURE FUEL PUMP FOR A FUEL INJECTION SYSTEM OF AN INTERNAL COMBUSTION ENGINE

(76) Inventors: Heinz Siegel, Stuttgart (DE); Hans-Peter Harnisch, Cadolzburg (DE); Matthias Schumacher, Asperg (DE); Oliver Albrecht, Bietigheim-Bissingen (DE); Uwe Mueller, Hemmingen (DE); Bernd Schroeder, Esslingen (DE); Timm Hollmann, Ludwigsburg (DE); Christian Wiedmann, Ludwigsburg (DE); Stefan Smetana, Salzburg (AT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/995,957

(22) PCT Filed: May 29, 2006
(86) PCT No.: PCT/EP06/62663

§ 371 Date: Feb. 4, 2010

(30) Foreign Application Priority Data
Jul. 19, 2005 (DE) 10 2005 033 634.5

(51) Int. Cl. F02M 37/06; F02M 59/36

(52) U.S. Cl. 123/508; 417/364

(57) ABSTRACT

The invention relates to a high pressure fuel pump for a fuel injection system of an internal combustion engine, having a pump housing in which is formed a working space, into which fuel can be supplied from a low pressure region of the radial piston pump, the working space being delimited by a pump piston which can be driven, in order to pressurize the fuel, by an external drive, in particular by a camshaft of an internal combustion engine, wherein in order to meter the fuel quantity supplied to the working space, a throttle device having a variable throttle action is arranged on or in the pump housing.

### PRIOR ART

The invention relates to a high-pressure fuel pump for a fuel injection system of an internal combustion engine, as defined by the preamble to claim 1.

One such high-pressure fuel pump is known in the form of a radial piston pump from German Patent Disclosure DE 103 22 604 A1. It is relatively compact in size, since the drive of the pump piston is effected not via a drive shaft built into the pump but by a camshaft of an internal combustion engine, for instance. The radial piston pump can be inserted at least partially into the housing of an internal combustion engine, so that a camshaft of the engine can drive the piston of the radial piston pump via roller or cup tappets.

The known radial piston pump has an electromagnetic quantity control valve, which directly actuates an inlet valve that is disposed upstream of the reception chamber of the radial piston pump.

In addition, European Patent Disclosure EP 0 299 337 A2 and German Patent Disclosure DE 197 29 791 A1 are mentioned for their general relevance.

Based on the radial piston pump described at the outset, the object of the present invention is to create an especially compact high-pressure pump with good efficiency.

This object is attained by a radial piston pump having the characteristics of claim 1.

Advantageous features are recited in the dependent claims.

### ADVANTAGES OF THE INVENTION

By integrating a throttle restriction with or onto the housing of the preferably single-stroke radial piston pump, a compact unit can be created. By dispensing with a drive shaft of its own, a small pump housing can be employed. This avoids energy losses that can otherwise occur if a pump has its own drive shaft that in turn has to be driven via driving means, such as toothed belts.

By means of the throttle restriction, the reception chamber of the radial piston pump can be supplied with exactly the fuel quantity needed in the high-pressure region of the injection system. As a result, hydraulic energy losses are minimized.

Characteristics recited in dependent claims 14 through 19 lead to an especially compact construction, with which bores provided in the pump housing can be disposed optimally. Transverse bores and the use of closure elements can then be avoided or at least minimized.

### DRAWINGS

Especially preferred exemplary embodiments of the present invention are described in further detail below in conjunction with the drawings. In the drawings:

FIG. 1 is a schematic view of an internal combustion engine with a fuel injection system and a single-stroke radial piston pump, in a first exemplary embodiment;

FIG. 2 is a perspective view of the radial piston pump of FIG. 1;

FIGS. 3 through 7 are sectional views of the radial piston pump of FIG. 1;

FIG. 8 is a schematic illustration of an internal combustion engine with a fuel injection system having a radial piston pump in a second embodiment and a further radial piston pump;

FIGS. 9 through 11 are sectional views of the radial piston pump of FIG. 8;

FIG. 12 is a perspective view of the further pump in FIG. 8;

FIG. 13 is a first sectional view through the further pump of FIG. 12; and

FIG. 14 is a second sectional view of the further pump of FIG. 12.

### DESCRIPTION OF THE EXEMPLARY EMBODIMENTS

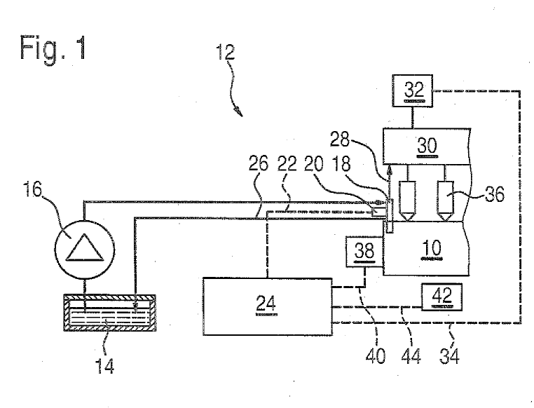

In FIG. 1, an internal combustion engine is identified by reference numeral 10. It is supplied with fuel via a fuel injection system identified overall by reference numeral 12. The fuel flows from a fuel collection container 14 (“tank”) to a prefeed pump 16, which delivers the fuel to a single-stroke radial piston pump 18. The pump 18 is driven directly by a camshaft of the engine 10. The pump 18 has a fuel metering unit 20, which is triggered via a control line 22 by a control unit 24.

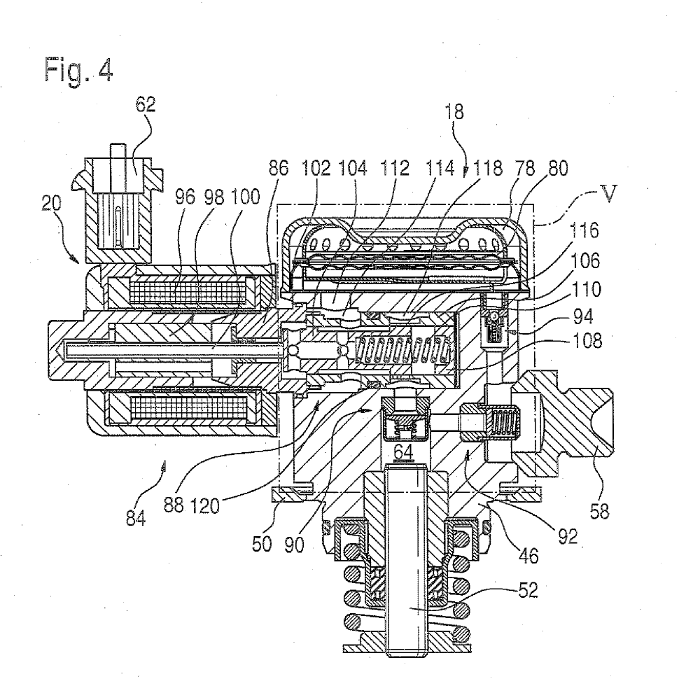

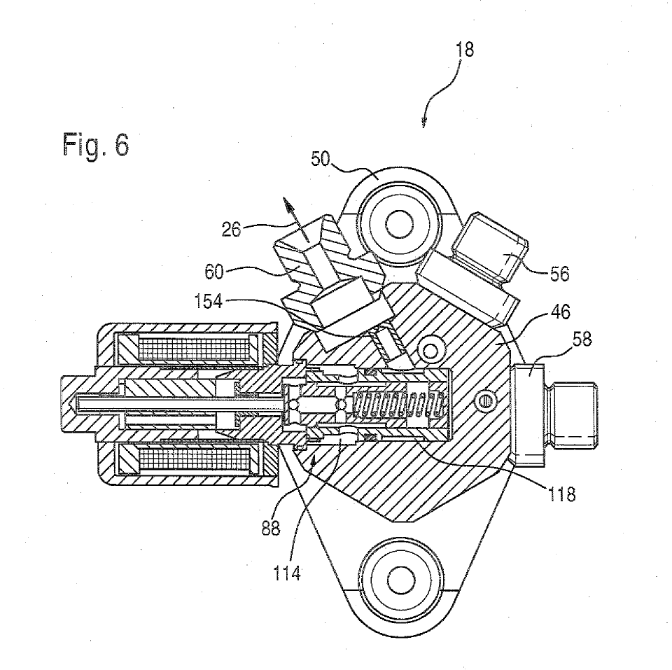

The fuel metering unit 20 has a throttle restriction, hereinafter called an intake throttle valve, which is described below in conjunction with FIGS. 4 and 6. When an intake throttle valve is used, a certain leak fuel quantity occurs. It is carried back to the tank 14 from the radial piston pump 18 via a line 26.

The radial piston pump 18 pumps fuel, subjected to high pressure, into a high-pressure line 28. This line discharges into a high-pressure reservoir 30. The pressure in the high-pressure reservoir 30 can be detected via a pressure sensor 32, and corresponding data can be forwarded to the control unit 24 with the aid of a data line 34.

The fuel, at high pressure, can be carried out of the high-pressure reservoir 30 to injection devices 36, which inject the fuel into respective combustion chambers of the engine 10. In FIG. 1, as an example, only two of a higher number of injection devices are shown.

For triggering the fuel metering unit 20, further data can be taken into account, such as the rpm of the engine 10 that can be detected by an rpm sensor 38 and forwarded to the control unit 24 via a data line 40. Via a temperature sensor 42 and a data line 44, the temperature, for instance of the engine coolant, can also be taken into account.

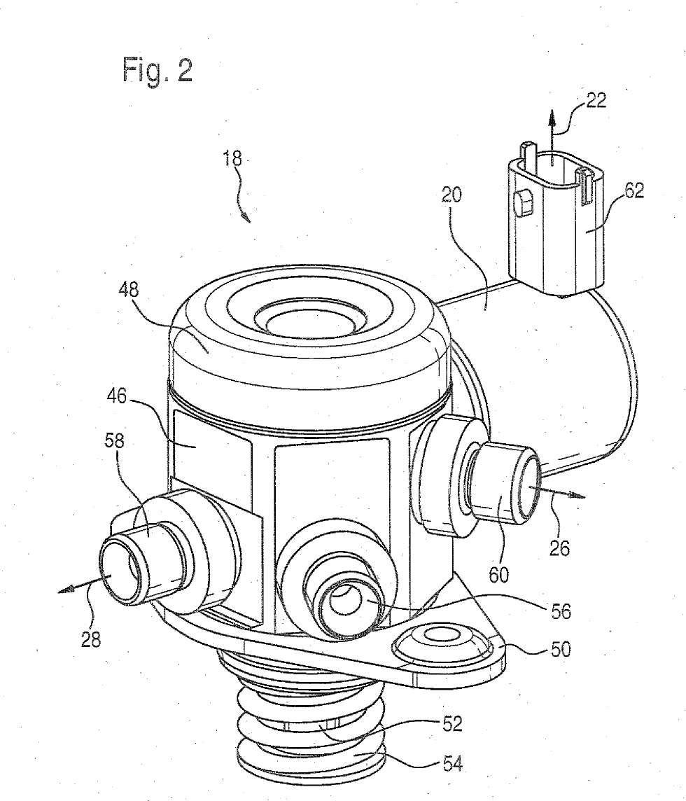

In FIG. 2, the radial piston pump 18 shown schematically in FIG. 1 is shown in perspective. The pump 18 has a pump housing 46, whose outer surface is approximately in the form of a hexagon (see FIG. 6). A housing cap 48 is disposed on the pump housing 46. The pump housing 46 can be secured to the engine 10 shown in FIG. 1 via a flange 50. Protruding from the pump housing 46 is a pump piston 52, which is surrounded by a piston spring 54. The pump piston 52 and the piston spring 54 can be inserted into the housing of the engine 10, where the pump piston 52 can be driven via roller or cup tappets by the camshaft of the engine 10.

Various connections for fuel lines are disposed on the outside of the pump housing 46. The middle connection in FIG. 2 is formed by a low-pressure connection stub 56, which is supplied from the prefeed pump 16 shown in FIG. 1 and leads to a low-pressure region of the radial piston pump 18. The connection shown on the left in FIG. 2 is formed by a high-pressure connection stub 58, which is associated with a high-pressure region of radial piston pump 18 and supplies the high-pressure line 28 (FIG. 1). The connection shown on the right in FIG. 2 is formed by a stub 60 that discharges into the line 26, through which the leak fuel quantity from the radial piston pump 18 can be delivered to the tank 14.

The fuel metering unit 20 is disposed on the pump housing 46, at a right angle to the longitudinal axis of the radial piston pump 18. This unit is provided with an electrical terminal 62, which can be made to communicate with the control line 22 (FIG. 1).

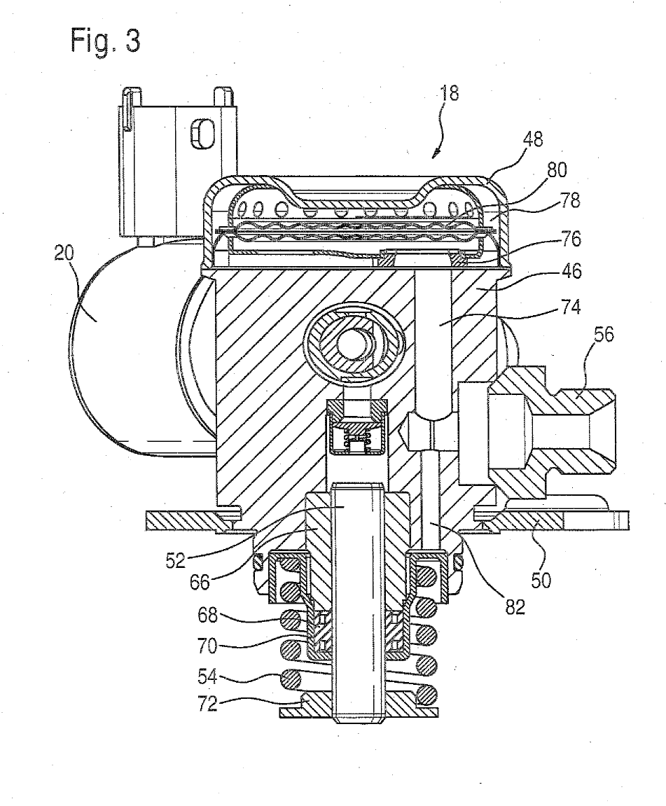

FIG. 3 shows a section through the radial piston pump 18, in a plane that extends through the low-pressure connection stub 56 (see FIG. 2). In the interior of the pump housing 46, a work chamber 64 is provided, to which fuel can be delivered in order to subject it to pressure as well by means of the pump piston 52. The pump piston 52 is displaceably supported in a cylinder element 66, which is solidly connected to the pump housing 46. The pump piston 52 and the cylinder element 66 are sealed off from one another via a sealing element 68 that is disposed in a seal holder 70.

The pump piston 52, on its end remote from the work chamber 64, has a spring plate 72 that is solidly connected to the pump piston 52. Between the spring plate 72 and the seal holder 70 is the piston spring 54, which is braced between these elements and presses the pump piston 52 in a direction facing away from the work chamber 64. As a result, the pump piston 52 and downstream roller or cup tappets can be kept in contact with the camshaft of the engine 10, this camshaft forming the external drive of the radial piston pump 18.

The fuel delivered to low-pressure connection stub 56 can be delivered through a bore 74 to a filter 76 and finally to a pressure damper chamber 78 that is defined by the pump lid 48. A pressure damper 80 is provided in the pressure damper chamber 78 in order to damp pressure fluctuations and to assure a high output by the high-pressure pump, even at high rpm of the engine 10 and even when there is an increased number of drive cams.

In the pump housing 46, a further bore 82 is provided, which is disposed between the seal holder 70 and the low-pressure connection stub 56. The bore 82 makes it possible for a leak fuel quantity to be carried away that comes from the work chamber 64 and passes between the pump piston 62 and cylinder element 66 and past the sealing element 68 to reach the seal holder 70.

FIG. 4 shows the radial piston pump 18 in a sectional plane that extends through the high-pressure connection stub 58 and the fuel metering unit 20.

This unit includes an electromagnet 84, a connection piece 86, and an intake throttle valve 88, which is disposed inside the pump housing 46.

Between the intake throttle valve 88 and the work chamber 64 is an inlet valve 90. Downstream of the work chamber 64, there is an outlet valve 92, which leads to the high-pressure connection stub 58. A bypass valve 94 is also provided between the pressure damper chamber 78 and the high-pressure connection stub 58.

The electromagnet 84 has a magnet coil 96 as well as a magnet armature 98, displaceable in the coil, with a magnet needle 100. The magnet needle 100 extends through the connection piece 86, and this connection piece is welded in leakproof fashion to the pump housing 46 via a welded connection 102.

The intake throttle valve 88 has a slide element 104, which is guided displaceably inside a cylinder element 106. The intake throttle valve 88 further includes a bracing element 108, which is press-fitted into the cylinder element 106, and a spring 110, which is braced on one end on a shoulder of the slide element 104 and on the other on the bracing element 108.

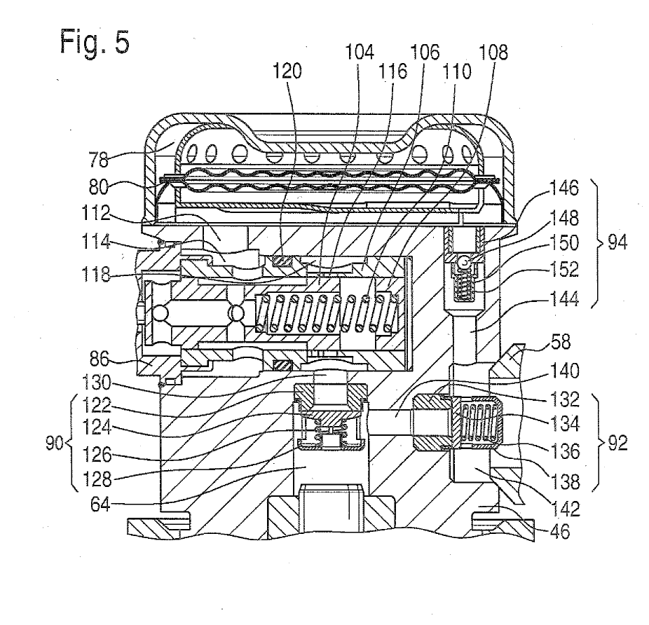

The fuel that reaches the pressure damper chamber 78 via the low-pressure connection stub 56 shown in FIG. 3 can reach a first annular chamber 114, surrounding the cylinder element 106, via a bore 112 in the pump housing 46. Depending on the position of the slide element 104 inside the cylinder element 106, the fuel can then reach a second annular chamber 118, via control openings 116 embodied in the cylinder element 106. This second annular chamber is sealed off from the first annular chamber 114 with the aid of a sealing element 120. The components described thus far of the intake throttle valve 88 are shown enlarged in FIG. 5. The construction of the inlet valve 90, outlet valve 92, and bypass valve 94 will now be described in conjunction with FIG. 5.

The inlet valve 90 has a counterpart plate 122, solidly joined to the pump housing 46, as well as a valve plate 124, which is urged by a valve spring 126 in the direction of the counterpart plate 122. The valve spring 126 is braced, on the side facing away from the valve plate, on a valve sleeve 128. The inlet valve 94 communicates hydraulically with the above-described second annular chamber 118 via a bore 130.

The outlet valve 92 likewise has a counterpart plate 132, which is connected to the pump housing 46, and also has a valve plate 134, a valve spring 136, and a valve sleeve 138. The outlet valve 92 communicates with the work chamber 64 via a bore 140. On the side toward the high-pressure connection stub 58, the outlet valve 92 protrudes into a bore 142, branching off from which is a further bore 144 in which the bypass valve 94 is disposed. This valve comprises a valve seat 146, solidly connected to the pump housing 46, as well as a valve body 148, a valve spring 150, and a valve 152.

For metering the fuel that reaches the work chamber 64 from the pressure damper chamber 78, the electromagnet 84 can be triggered appropriately. The electromagnet 84 and the intake throttle valve 88 can be designed such that in the currentless state of the electromagnet 84, the intake throttle valve is completely open or completely closed. In FIGS. 4 and 5, the electromagnet 84 is shown in the currentless state; the slide element 104 of the intake throttle valve 88 closes the control openings 116, so that no fuel from the pressure damper chamber 78 can reach the work chamber 64. When current is supplied to the electromagnet 84, the magnet armature 98 and magnet needle 100 can exert a pressure force on the slide element 104, causing this element to be displaced counter to the action of the spring 110 and correspondingly opening the control openings 116. As a result of the opening of the control openings 116, fuel can flow out of the first annular chamber 114 into the second annular chamber 118 and from there through the inlet valve 90 to reach the work chamber 64. The pressure force of the spring 110 can be adjusted upon assembly of the intake throttle valve 88 by press-fitting the bracing element 108 into a suitable position inside the cylinder element 106 in accordance with the desired initial stress of the spring 110.

If the electromagnet 84 is supplied more weakly with current or is no longer supplied with current, then the spring 110 presses the slide element 104 back into the position shown in FIG. 4.

The inlet valve 90 opens when the pump piston 52 moves out of the work chamber 64. The pressure built up upstream of the inlet valve 90 by the prefeed pump 16 suffices to move the valve plate 124 away from the counterpart plate 122, counter to the action of the valve spring 126, so that fuel from the bore 130 can reach the work chamber 64.

The inlet valve 90 closes automatically at the end of the intake phase. As a result of the upward motion of the pump piston 52, the fuel contained in the work chamber 64 can be subjected to high pressure and delivered via the bore 140, with opening of the outlet valve 92, to the high-pressure connection stub 58. To enable assuring emergency operation of the injection system 12 even if the intake throttle valve 88 is defective or is at least temporarily out of operation, the bypass valve 94 is provided. Trouble can occur, for instance when an intake throttle valve 88 has been closed without current, if the supply of current to the electromagnet 84 is interrupted or incorrect. In order nevertheless to be able to assure that the high-pressure connection stub 58 is supplied with fuel, the bypass valve 94 can open, at the pressure that is generated by the prefeed pump 16. Thus fuel from the pressure damper chamber 78 can be delivered to the bore 144, the bore 142, and the high-pressure connection stub 58. The opening pressure of the bypass valve 94 should be less than the sum of the opening pressures of the inlet valve 90 and outlet valve 92. As a result, it can be attained when the engine 10 is put into operation, the bypass valve 94 briefly opens, as long as the radial piston pump 18 has not yet built up high pressure. The brief opening of the bypass valve 94 assures that this valve remains functional and will not become contaminated with dirt particles over the course of time. During the normal operation of the radial piston pump 18, high pressure prevails in the high-pressure region of the radial piston pump 18 and thus also in the bore 144, and thus the valve body 148 is pressed into the valve seat 146, and the bypass valve 94 remains closed.

In FIG. 6, the radial piston pump 18 is shown in a sectional plane that extends perpendicular to the sectional plane selected in FIG. 4.

Between the second annular chamber 118, downstream of the intake throttle valve 88, and the stub 60 that communicates with the return 26, a zero-feed throttle restriction 154 is disposed. Between the slide element 104 and the cylinder element 106 of the intake throttle valve 88, leakage occurs during operation of the fuel injection system 12. If the fuel quantity required by the engine 10 is less than the leak fuel quantity of the intake throttle valve 88, then this quantity can be carried away through the zero-feed throttle restriction 154 into the line 26 to the tank 14.

The design of the zero-feed throttle restriction 154 depends primarily on the pressure difference at this throttle restriction. In normal operation, the least pressure upstream of the zero-feed throttle restriction 154 is the sum of the vapor pressure of the fuel and the opening pressure of the inlet valve 90. Downstream of the zero-feed throttle restriction 154, atmospheric pressure prevails as a rule, or in other words approximately 1 bar. To make it possible for a fuel quantity to be diverted, the pressure upstream of the zero-feed throttle restriction 154 must be greater than downstream of it. For that reason, the opening pressure of the inlet valve 90 should not be less than 1 bar. The fuel quantity that flows out, at the given pressure difference, via the zero-feed throttle restriction 154 must be greater than the leak fuel quantity of the intake throttle valve 88, so that the case of zero feeding can also be covered. The inside diameter of the zero-feed throttle restriction 154 should be at least 0.3 mm, to prevent the zero-feed throttle restriction 154 from becoming blocked by dirt particles. It is understood that the zero-feed throttle restriction 154 may also be integrated with the stub 60.

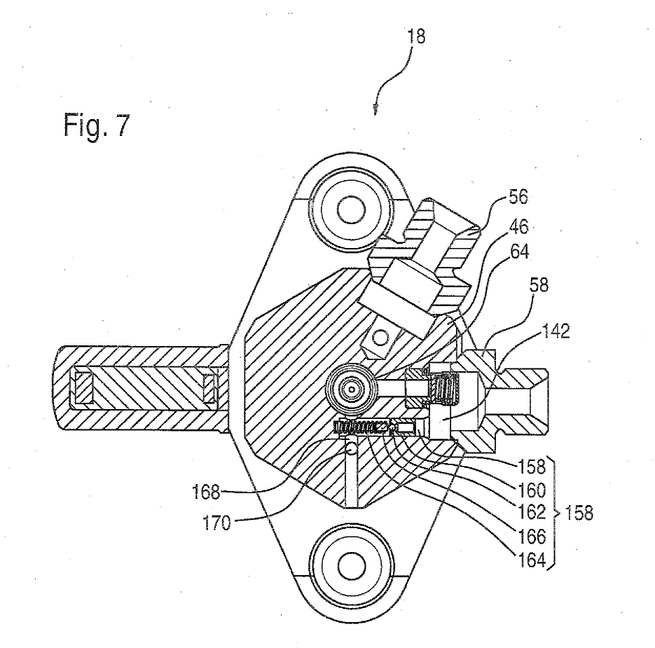

FIG. 7 shows the radial piston pump 18 in a sectional plane that extends through the high-pressure connection stub 58 and perpendicular to the sectional plane of FIG. 4. The work chamber 64 communicates with the high-pressure connection stub 58 via the outlet valve 92. This high-pressure region can be made to communicate with the work chamber 64 again with the aid of a pressure limiting valve 156, in order to protect the fuel injection system 12 from pressures that exceed the allowable maximum pressure. The pressure limiting valve 156 is disposed in a bore 158 that discharges on the outlet side of the outlet valve 92 in the bore 142. The pressure limiting valve 156 has a valve seat 160, a valve body 162, a valve spring 164, and a spring receptacle 166. The valve spring 164 is braced on one end on the spring receptacle 166 and on the other on the end of the bore 158. The bore 158 communicates with the work chamber 64 via a transverse bore 168. The transverse bore 168 is sealed off from the outside of the radial piston pump 18 with the aid of a closure body 170.

If the pressure applied in the bore 142 exceeds an allowable maximum pressure, then the valve body 162 can be moved out of the valve seat 160, counter to the pressure force of the valve spring 164, so that fuel can be carried back into the work chamber 64 through the transverse bore 168. The initial tension of the valve spring 164 should thus be selected such that the opening pressure of the pressure limiting valve 156 amounts to the highest possible maximum pressure in the bore 142.

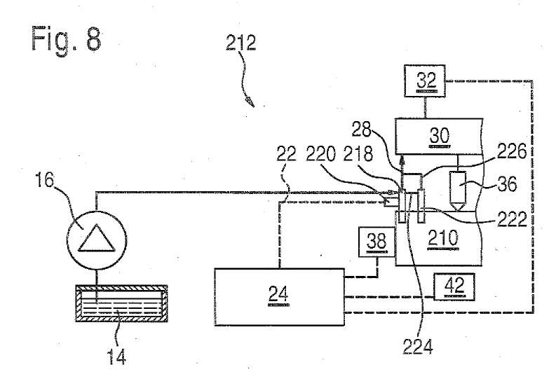

A second exemplary embodiment will now be described, in conjunction with FIGS. 8-14.

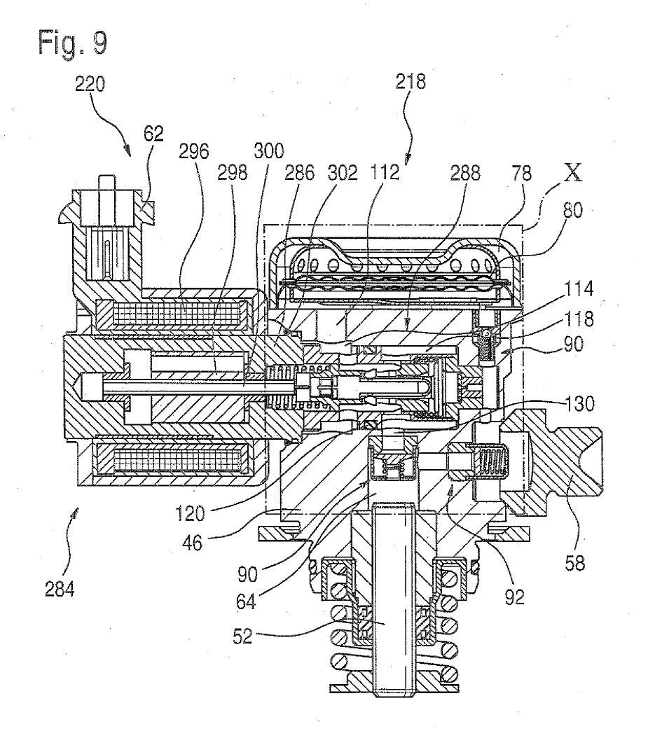

In FIG. 8, a fuel injection system 212 is shown schematically. The components that match those of the fuel injection system 12 of FIG. 1 are identified by the same reference numerals. In this respect, the description of the first exemplary embodiment is applicable to its full extent. In a distinction from the fuel injection system 12, the fuel injection system 212 has a radial piston pump 218 that requires no return (comparable to the line 26 in FIG. 1). The radial piston pump 218 has a fuel metering unit 220 that is modified compared to the first exemplary embodiment and is described below in conjunction with FIGS. 9-11. In addition to the radial piston pump 218, a further pump 222 is provided. The radial piston pump 218 and the further pump 222 are each driven by a camshaft of an internal combustion engine 210. The further pump 222 is supplied from the radial piston pump 218 with the aid of a line 224. Via a high-pressure line 226, the further pump 222 can deliver fuel, subjected to high pressure, to the high-pressure line 28, from which the fuel reaches the high-pressure reservoir 30. To attain good overall efficiency, the line 224 should be as short as possible, and in particular shorter than 30 cm. By the use of a further pump 222, the maximum deliverable fuel quantity of the fuel injection system 212 can be increased compared to the fuel injection system 12. If a further increase is desired, then additional pump elements can be connected to the radial piston pump 218.

FIG. 9 shows the radial piston pump 218 in a sectional plane that extends through the fuel metering unit 220.

The radial piston pump 218 and the fuel metering unit 220 include a pump housing 46, with a work chamber 64 that is preceded upstream by an inlet valve 90 and followed downstream by an outlet valve 92. An electromagnet 284 that is triggerable via an electrical terminal 62 is provided on the pump housing 46. The electromagnet 284 has a magnet coil 296, a magnet armature 294, and a magnet needle 300. The electromagnet 284 is connected to the pump housing 46 via a connection piece 286 via a welded connection 302.

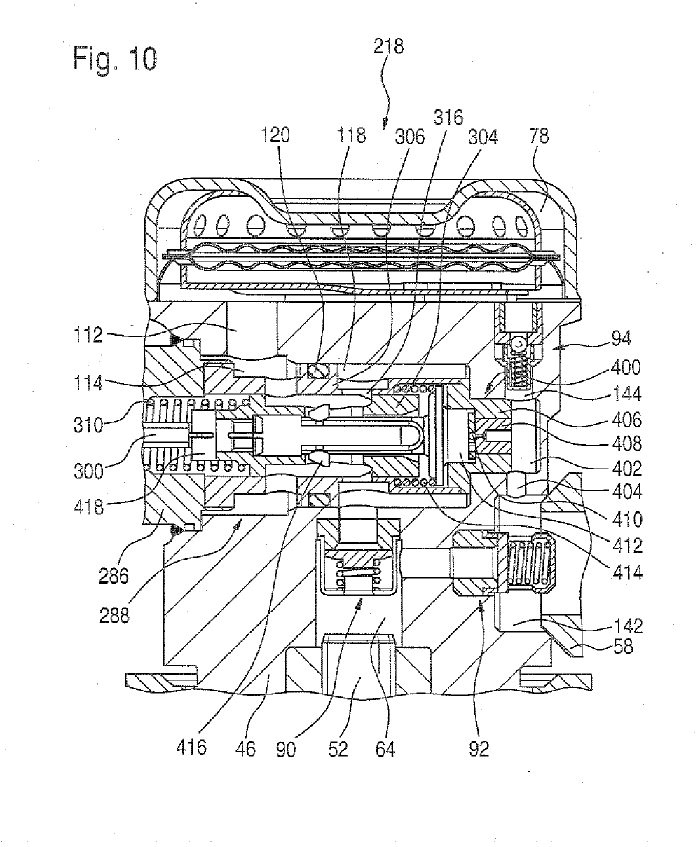

The electromagnet 284 opens an intake throttle valve 288, which is modified compared to the intake throttle valve 88 described in conjunction with the first exemplary embodiment. This modified intake throttle valve will be described hereinafter in conjunction with FIG. 10. The installation situation of the intake throttle valve 288 is comparable to that of the intake throttle valve 88. Thus the fuel delivered to the pressure damper chamber 78 can flow via the bore 112 into a first annular chamber 114, via the intake throttle valve 288 into a second annular chamber 118, and from there into a bore 130 to reach the inlet valve 90 and finally the work chamber 64. The first annular chamber is sealed off from the second annular chamber with the aid of a sealing element 120.

The intake throttle valve 288 and its mode of operation will now be described in conjunction with FIG. 10, in which the detail marked X in FIG. 9 is shown. The intake throttle valve 288 can be coupled to a pressure limiting valve 400. The intake throttle valve 288 has a cylinder element 306, which is solidly connected to the connection piece 286 and in which a slide element 304 is displaceably supported. The slide element 304 is pressed in the direction of the pressure limiting valve 400 with the aid of a spring 310. Depending on the position of the slide element 304, control openings 316 embodied in the cylinder element 306 are opened or closed.

The pressure limiting valve 400 discharges, on the side remote from the intake throttle valve 288, in a bore 402 that is communication with the bore 144 for the bypass valve 94. The bore 402 communicates, on the side opposite the bypass valve 94, with a bore 404 that discharges in the bore 142 on the outlet side of the outlet valve 92. The bore 142 is located adjacent to the high-pressure connection stub 58.

The pressure limiting valve 400 has a pressure piece 406, which is solidly connected to the pump housing 46. The pressure piece 406 is also solidly connected to the cylinder element 306 of the intake throttle valve 288. A valve seat 408 is press-fitted into the pressure piece 406, and a valve body 410 of a coupling element 412 is associated with this valve seat. The coupling element 412 is braced via a valve spring 414 on the cylinder element 306, so that the valve body 410 is pressed into the valve seat 408. The coupling element 412 has slaving elements 416, which can cooperate with the slide element 304 of the intake throttle valve 288. This will be described in further detail hereinafter.

The slide element 304 is connected, on the side opposite the pressure limiting valve 400, to the magnet needle 300 of the electromagnet 284 via a connecting element 418.

The magnet valve 284 shown in FIG. 9 is open in its currentless state, so that fuel from the first annular chamber 114 can reach the second annular chamber 118 via the control openings 116. The spring 310 urges the slide element 304 in the direction of the pressure limiting valve 400.

When current is supplied to the electromagnet 284, the magnet needle 300 is pulled out of the pump housing 46. This motion is transmitted via the connecting element 418 to the slide element 304, so that the slide element 304 gradually closes the control openings 316. As current continues to be supplied to the electromagnet 284, the slide element 304 engages the slaving elements 416 of the coupling element 412, so that the coupling element 412 and the valve body 410 disposed on it are subjected to an opening force counter to the action of the valve spring 414. If the opening force is high enough, the pressure limiting valve 400 is opened and establishes a communication among the bores 142, 404 and 402 and the first annular chamber 114, so that fuel subjected to high pressure can be carried from the high-pressure side of the radial piston pump 218 back to the low-pressure side. The fuel thus diverted can be received in the pressure damper chamber 78.

Diverting the fuel that is at high pressure is advantageous so as to make it possible to reduce an undesirably high pressure in the high-pressure region of the radial piston pump 218. Such situations occur in the overrunning mode, for instance, or upon shutoff of the engine 210.

For the manufacture of the bores 144 and 404, it is advantageous if they are aligned with one another, so that bores can be made in one machining operation. If both bores 144 and 404 have the same diameter, then both bores can be made simultaneously with a continuously identical diameter with the same drill.

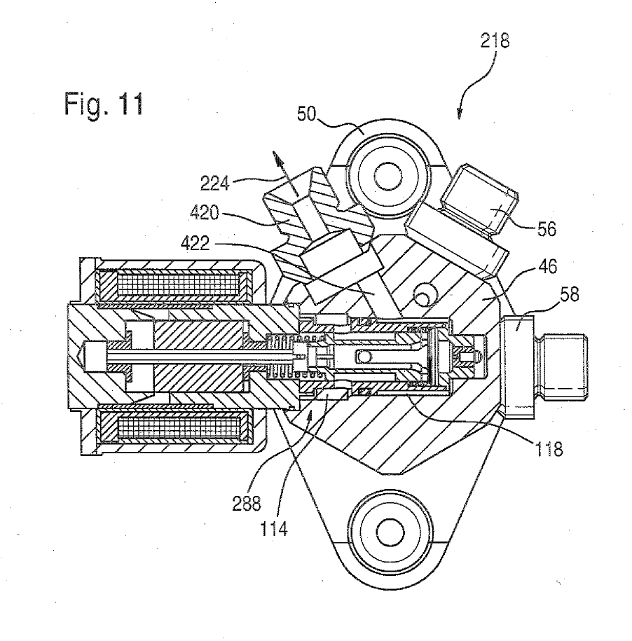

FIG. 11 shows the radial piston pump 218 in a sectional plane that is perpendicular to the plane chosen in FIG. 9. The pump housing 46 with the high-pressure connection stub 58 and the low-pressure connection stub 56 can all be seen. A connection stub 420 for the further pump 222 schematically shown in FIG. 8 is also provided. The connection stub 420 leads to the line marked 224 in FIG. 8.

The fuel delivered to the radial piston pump 218 can flow via the first annular chamber 114 and via the intake throttle valve 288 to reach the second annular chamber 118. From there, it can be carried to the connection stub 420 via a bore 422.

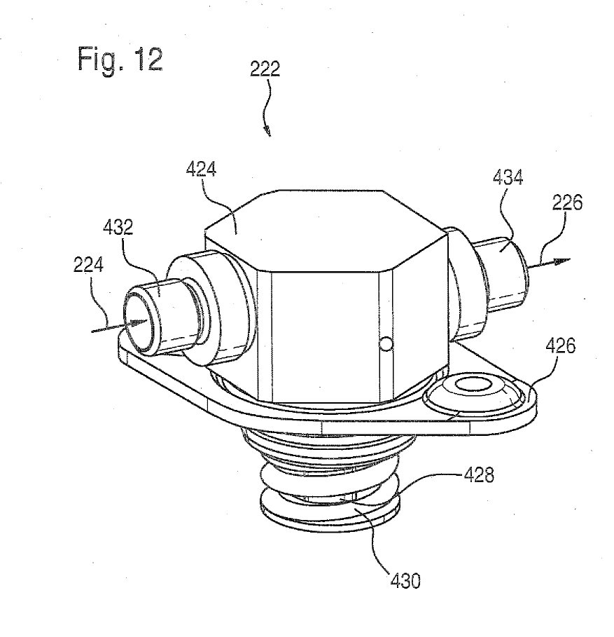

FIG. 12 shows the further pump 222 in a perspective view. The pump 222 has a pump housing 424, which can be secured to the engine 210 via a flange 426. The pump 222 has a pump piston 428 and a piston spring 430, which can both be introduced into the housing of the engine 210 so that the pump piston 428 can be driven by a camshaft of the engine 210.

A low-pressure connection stub 432 is provided on the pump housing 424 and is supplied with fuel by the radial piston pump 218 via the line 224. On the high-pressure side of the pump 222, a high-pressure connection stub 434 is provided, which leads to the high-pressure line 226.

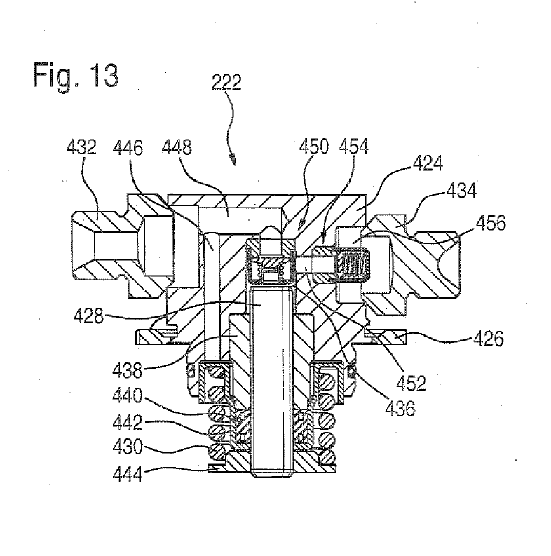

The pump 222 is shown in FIG. 13, in a sectional plane through the pump housing 424 and the pump piston 428.

The pump piston 428 defines a work chamber 436 and is supported displaceably in a cylinder element 438. The cylinder element 438 is solidly connected to the pump housing 424. The sealing of the cylinder element 438 and the pump piston 428 is effected via a sealing element 440 that is received in a seal holder 442. A leak fuel quantity emerging via the sealing element 440 can be delivered via a bore 446 to a bore 448 in the low-pressure region of the pump 222.

An inlet valve 450 is disposed upstream of the work chamber 436, and a bore 452 that leads to an outlet valve 454 is disposed downstream of the work chamber. On the outlet side of the outlet valve 454, a bore 456 is provided, which leads to the high-pressure connection stub 434.

Fuel delivered through the low-pressure connection stub 432 flows via the bore 448 to reach the inlet valve 450, which opens when the piston 428 moves out of the work chamber 436. The motion of the pump piston 428 out of the work chamber is effected with the aid of the piston spring 430, which presses the pump piston 428 against a drive cam of the engine 210. If the pump piston 428 is moved into the work chamber 436 by the camshaft of the engine 210, then the fuel subjected to pressure flows via the bore 452 to reach the outlet valve 454. This valve opens, and the fuel subjected to pressure reaches the high-pressure connection stub 434 and from there the high-pressure line 226 (see FIG. 8).

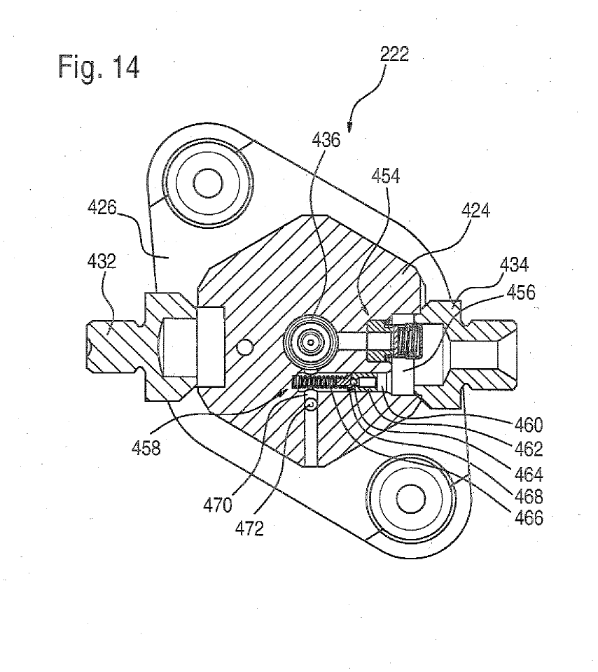

In FIG. 14, the pump 222 is shown in a sectional plane perpendicular to the plane chosen in FIG. 13. To protect the fuel injection system 212 against an overload, a pressure limiting valve 458 is provided, by which the bore 456, adjacent to the high-pressure connection stub 434, can be made to communicate with the work chamber 436. The pressure limiting valve 458 is disposed in a bore 460 and has a valve seat 462, a valve body 464, and a valve spring 466 that is braced on a spring holder 468 and on the end of the bore 460. The bore 460 communicates with the work chamber 436 via a transverse bore 470. The transverse bore 470 is closed off from the outside by a closure body 472. If the fuel located in the bore 456 exceeds an allowable maximum pressure, the pressure limiting valve 458 is opened, so that the fuel can flow through the bore 460 and the transverse bore 470 back into the work chamber 436.

1-14. (canceled)

15. A high-pressure fuel pump for a fuel injection system of an internal combustion engine, the pump comprising a pump housing, a work chamber in the pumps housing for receiving fuel delivered from a low-pressure region of the radial piston pump, the work chamber being defined by a pump piston that can be acted upon by an external camshaft or eccentric camshaft of an internal combustion engine, and a throttle restriction with variable throttling action disposed on or in the pump housing for metering the fuel quantity delivered to the work chamber.

16. The high-pressure fuel pump as defined by claim 15, further comprising an electromagnet operable to trigger the throttle restriction the throttle restriction being disposed inside the pump housing, and the electromagnet being disposed outside the pump housing.

17. The high-pressure fuel pump as defined by claim 16, wherein the throttle restriction and the electromagnet are connected to one another by a connection piece.

18. The high-pressure fuel pump as defined by claim 15, wherein the throttle restriction and/or the electromagnet and/or the connection piece with the pump housing are solidly joined to one another by welding.

19. The high-pressure fuel pump as defined by claim 15, further comprising a bypass valve operable when open to permit fuel to be delivered from the low-pressure region to the high-pressure region of the radial piston pump, bypassing the intake throttle valve.

20. The high-pressure fuel pump as defined by claim 16, further comprising a bypass valve operable when open to permit fuel to be delivered from the low-pressure region to the high-pressure region of the radial piston pump, bypassing the intake throttle valve.

21. The high-pressure fuel pump as defined by claim 19, further comprising an outlet valve connected downstream of the work chamber the opening pressure of the bypass valve being less than the sum of the opening pressures of the inlet valve and outlet valve.

22. The high-pressure fuel pump as defined by claim 21, further comprising an outlet valve connected downstream of the work chamber the opening pressure of the bypass valve being less than the sum of the opening pressures of the inlet valve and outlet valve.

23. The high-pressure fuel pump as defined by claim 15, further comprising a pressure limiting valve between the high-pressure region of the radial piston pump and the work chamber, the opening pressure of the pressure limiting valve being equivalent to the maximum allowable pressure in the high-pressure region.

24. The high-pressure fuel pump as defined by claim 16, further comprising a pressure limiting valve between the high-pressure region of the radial piston pump and the work chamber, the opening pressure of the pressure limiting valve being equivalent to the maximum allowable pressure in the high-pressure region.

25. The high-pressure fuel pump as defined by claim 19, further comprising a pressure limiting valve between the high-pressure region of the radial piston pump and the work chamber, the opening pressure of the pressure limiting valve being equivalent to the maximum allowable pressure in the high-pressure region.

26. The high-pressure fuel pump as defined by claim 21, further comprising a pressure limiting valve between the high-pressure region of the radial piston pump and the work chamber, the opening pressure of the pressure limiting valve being equivalent to the maximum allowable pressure in the high-pressure region.

27. The high-pressure fuel pump as defined by claim 15, further comprising a pressure limiting valve, a coupling element operable to coupe the throttle restriction to the pressure limiting valve for opening this pressure limiting valve, and the opened pressure limiting valve establishing a communication between the high-pressure region of the radial piston pump and the throttle restriction so that fuel can be delivered from the high-pressure region via the throttle restriction to the low-pressure region of the radial piston pump.

28. The high-pressure fuel pump as defined by claim 15, further comprising at least one further pump communicating on the inlet side with at least one fuel connection embodied on the pump housing of the radial piston pump, the at least one fuel connection communicating with a region of the radial piston pump that is located hydraulically between the intake throttle valve and the work chamber.

29. The high-pressure fuel pump as defined by claim 16, further comprising at least one further pump communicating on the inlet side with at least one fuel connection embodied on the pump housing of the radial piston pump, the at least one fuel connection communicating with a region of the radial piston pump that is located hydraulically between the intake throttle valve and the work chamber.

30. The high-pressure fuel pump as defined by claim 15, wherein the throttle restriction extends along an axis disposed essentially at a right angle to the stroke axis of the pump piston.

31. The high-pressure fuel pump as defined by claim 15, wherein the throttle restriction is disposed spatially between the work chamber and the low-pressure region.

32. The high-pressure fuel pump as defined by claim 15, further comprising an inlet valve disposed, in the direction of the stroke axis of the pump piston, spatially between the work chamber and the throttle restriction.

33. The high-pressure fuel pump as defined by claim 19, wherein the bypass valve is disposed, parallel to the stroke axis of the pump piston, spatially between the low-pressure region and a high-pressure region downstream of the work chamber.

34. The high-pressure fuel pump as defined by claim 21, wherein the pressure limiting valve is disposed essentially parallel to the throttle restriction and/or to an outlet valve.
